(19) United States
(12) Patent Application Publication
(10) Pub. No.: US 2016/0195048 A1
(43) Pub. Date: Jul. 7, 2016

(54) Switching Device with Air Gap Insulation in Cylinder Head Flange

(71) Applicant: Mann+Hummel GMBH, Ludwigsburg (DE)

(72) Inventors: Alexander Korn, Gueglingen (DE); Heinz Buehl, Erlenbach (DE); Herbert Pietrowski, Pleidelsheim (DE)

(21) Appl. No.: 14/987,135

(22) Filed: Jan. 4, 2016

(30) Foreign Application Priority Data
Jan. 7, 2015 (DE) 102015000016.0

(51) Int. Cl. F02M 35/10

(52) U.S. Cl. CPC F02M 35/10301; F02M 35/10321

(57) ABSTRACT

A switching device for influencing the air current in at least one air intake channel of an internal combustion engine, wherein the switching device comprises: a housing having an open interior through which the air intake channel extends; at least one switching unit arranged in the housing and having with at least one switching element for at least partially closing and opening the at least one intake channel; wherein the housing is received in a cylinder head of an internal combustion engine and which has a distance corresponding to an air gap between the housing and the cylinder head in a radial direction.

### TECHNICAL FIELD

The invention relates to a switching device for a suction system for intake gas, in particular intake air, of an internal combustion engine, in particular of a motor vehicle, for opening or partially closing at least one inlet channel of a combustion chamber, wherein a switching unit is introduced in an outer end of the channel of the suction system or in an additional intermediate flange between the suction system and cylinder head, wherein this outer end or the intermediate flange protrudes into a deep recess in the cylinder head of the internal combustion engine, which extends close to an intake valve.

### BACKGROUND OF THE INVENTION

An air intake system for an internal combustion engine is known from WO 2009/149724 Al with a controllable air flap for influencing the air stream, for example for vortex formation or tumble formation, of the inflowing air and thus the mixture formation of the combustion process.

Tumble current refers to a cylindrical current, the rotational axis of which lies substantially transverse to the axis of the combustion chamber, i.e. substantially parallel to the direction of the crankshaft. Controllable flaps in air intake systems which can cause currents of this kind in the operative position are called tumble flaps. Vortex current refers to a current whose rotational axis substantially corresponds to the axis of the cylinder bore. Controllable flaps in air intake systems which can effect currents of this kind in the combustion chamber are called vortex flaps.

The air intake system shown in WO 2009/149724 A1 for an internal combustion engine with a cylinder head has a respective undivided intake channel entry for two gas intake channels with two gas intake valves of a cylinder, wherein an intermediate wall between the two gas intake channels begins downstream from the intake channel entry, with an air flap, which lies in the cross-section of an air supply channel and which has an axis of rotation X, which lies substantially in a cross-sectional plane of the air supply channel, wherein the air flap is adjustable between a neutral position, in which it is oriented in the longitudinal direction of the air supply channel, and an operative position, in which it lies transverse in the air supply channel and partially or completely blocks the cross-section of the channel.

A disadvantage is that the tumble flaps are arranged relatively far away from the combustion chamber (intake valve). The intensity of the tumble thereby largely increases until the flow reaches the cylinder. Additional components, such as channel separating plates, are necessary in order to counteract this effect. Through a long flow path of the tumble turbulence in the cylinder head, the combustion air is disadvantageously heated.

### SUMMARY OF THE INVENTION

The object of the invention is to design a switching element of the type mentioned above in order to remedy these disadvantages.

The invention differs from the prior art in that a switching device is accommodated in the cylinder head in the region of the intake valves and the housing of the switching unit is thermally insulated from the cylinder head.

The switching device may comprise individual switching units which are arranged in the intake channels in the cylinder head of an internal combustion engine. Here, the housings of multiple switching units may be connected or may be formed as separate housings.

The housing of the switching unit may be a part of the suction system. It may be integrally formed by the channels of the suction system or may be inseparably connected with the channels, for example welded or molded.

Alternatively, the housing of the switching unit may be configured in the form of an intermediate flange between the suction system and the cylinder head.

Here, the intermediate flange with the switching unit can be firmly connected to the suction system and/or to the cylinder head. In an alternative embodiment, the intermediate flange is attached to the internal combustion engine by clamping between the suction system and the cylinder head.

The switching unit protrudes into a deep recess in the cylinder head nearly up to the intake valves. Due to this arrangement, when the flap is engaged, a tumble turbulence is first generated shortly before the intake valve. This leads to a very effective tumble current in the combustion chamber, since the flow path for the tumble current is kept short.

In an advantageous embodiment, the distance between the flap of the switching unit in the open state and the intake valve of the combustion chamber corresponds approximately to the dimension of the diameter of an intake valve of the combustion chamber.

For thermal insulation, a distance is provided in the radial direction between the housing of the switching unit and the cylinder head with respect to the run of the intake channel in the cylinder head.

This gap prevents a direct heat transfer from the heated cylinder head to the housing of the switching unit and thus to the through-flowing air.

The housing of the switching unit may advantageously be made of plastic. This reduces the heat transfer relative to a housing made of other materials, for example metal.

In a particularly advantageous embodiment, the thermal insulation of the combustion air from the cylinder head occurs due to the lower thermal conductivity of the plastic and the additional air gap insulation.

The switching device comprises at least one switching unit. The number of switching units and switching elements arranged therein varies depending on the number of cylinders of the internal combustion engine and the number of intake channels.

The switching elements are controlled according to a predetermined characteristic diagram. According to the rotational speed or load state, turbulence is created in the intake channel depending on the operating state of the internal combustion engine. This occurs through the introduction of a switching element in the intake channel, which reduces the cross-section and, by means of an edge, creates turbulence in the intake channel, which continues into the combustion chamber.

At maximum deflection, the switching elements close, for example, up to approximately 2/3 of the current cross-section of the intake channel.

In an advantageous embodiment, the switching element is formed as a flap, which is pivoted about an axis. The flap is particularly advantageously asymmetrically formed, with a pivot axis outside the current cross-section of the intake channel.

In an alternative embodiment, the switching element is designed as a rotary vane. A shift drum rotates about the longitudinal axis and, by means of its geometric design in the area of the intake channel, opens or closes this partially according to the operating state.

The at least one switching element can be actuated via a pneumatic, hydraulic or electric drive.

One drive may operate all the switching elements of a switching device. Alternatively, individual switching elements or groups of switching elements may each be outfitted with a drive.

### BRIEF DESCRIPTION OF THE DRAWINGS

Further advantages, features and details of the invention will become apparent from the following description, in which an exemplary embodiment of the invention is explained in more detail with reference to drawings. A person skilled in the art will also appropriately consider the features disclosed in the drawings, the description and the claims individually and combine them into further sensible combinations.

FIG. 1 shows a sectional view of a switching device, arranged in a cylinder head of an internal combustion engine in an embodiment with a switching flap;

FIG. 2 shows a sectional view of a switching device, arranged in a cylinder head of an internal combustion engine in an embodiment with a shift drum;

FIG. 3 shows a view of a switching device arranged in a cylinder head,

FIG. 4 shows a sectional view of a switching device according to section A-A of FIG. 3 with introduced flap;

FIG. 5 shows a perspective sectional view of the switching device according to FIG. 4;

FIG. 6 shows a sectional view of a switching device according to section A-A of FIG. 3 with completely opened cross-section;

FIG. 7 shows a perspective sectional view of the switching device according to FIG. 6;

FIG. 8 shows a view of an alternative embodiment of a switching device with two subchannels and introduced flap arranged in a cylinder head;

FIG. 9 shows a view of the switching device according to FIG. 8 with completely opened cross-section.

### DETAILED DESCRIPTION OF THE INVENTION

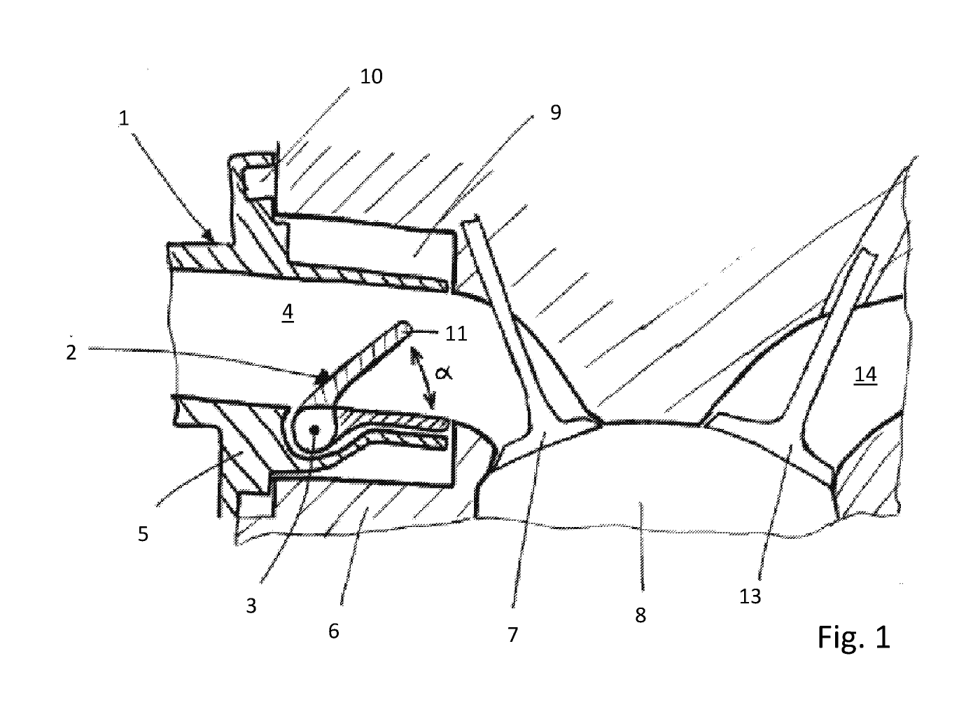

FIGS. 1 to 9 show embodiments of a switching unit according to the invention. Identical components in the individual figures are provided with the same reference characters.

FIG. 1 shows a sectional view of a switching unit 1 along a fluid path of a cylinder of an internal combustion engine with pivotable switching element 2. The switching element 2 is pivotably mounted about an axis 3 with the angle α. The switching element 2 reduces the free-flowing cross-section of the air intake channel 4, in order to generate turbulence in the air intake channel 4. The housing 5 of the switching unit 1 protrudes into the cylinder head 6 of the internal combustion engine, in order to arrange the switching element 2 as closely as possible to the intake valve 7 of the combustion chamber 8. An air gap 9 is provided between the switching unit 1 and the cylinder head 6, in order to thermally decouple the switching unit and the air flowing therein from the temperature of the cylinder head.

A sealing element (not shown), arranged in a sealing groove 10 against the cylinder head 6, seals the air gap and the housing 5 of the switching unit 1 from the environment.

The air flowing through the air intake channel 4 at the intake valve 7 into the combustion chamber of the internal combustion engine is fed after combustion through the outlet channel 14 at the outlet valve 13 out of the cylinder head 6 in the direction of the exhaust system.

In FIG. 1, the switching element 2 is designed as a pivotable flap 11. The flap 11 is received in the housing 5 of the switching unit 1 such that, when the flap is completely open, the free-flowing cross-section of the air intake channel 4 corresponds to the cross-section of the air intake channel 4 before and after the flap, and the flap does not reduce the cross-section.

For the creation of turbulence in the air current in the air intake channel 4, the flap may be pivoted into the air current about the axis 3, thus steplessly reducing the cross-section.

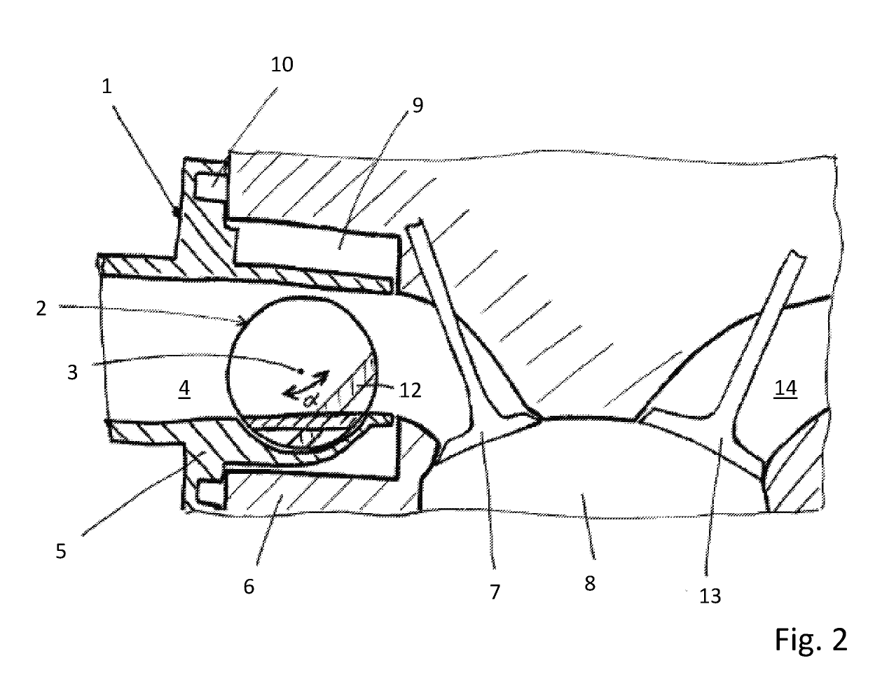

FIG. 2 shows a switching unit 1 as in FIG. 1 in an alternative embodiment of the switching element 2 as a rotary vane 12.

The rotary vane 12 is a body which rotates about the axis 3, which body has a contour in the region of the air intake channel 4 which, during rotation of the rotary vane 12 about the angle α, is rotated into the air current and thus continuously reduces the cross-section of the air intake channel 4 in the region of the rotary vane 12 and causes turbulence in the current.

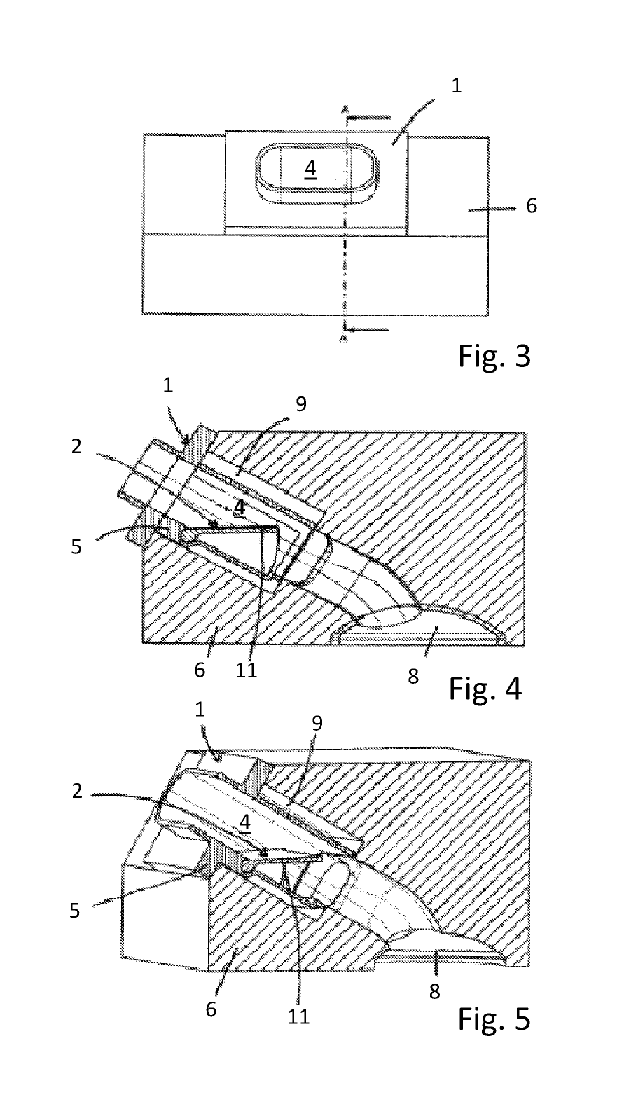

FIG. 3 shows a view of a switching unit 1 in a cylinder head 6 in a direction of viewing of the air intake channel 4. Shown is the section line A-A, along which the sections of FIGS. 4 to 7 are cut.

FIG. 4 shows a section along the section line A-A of FIG. 3 through the air intake channel 4 similar to FIG. 1 with the switching element 2 in the form of a flap 11 in the pivoted out position. When the intake valve (not shown in FIGS. 4 to 7) is open, air flows through the intake valve past the cross-section reduced by the introduced flap 11. Turbulence is thus generated, which improves the combustion in the combustion chamber 8.

FIG. 5 shows a perspective sectional view of the arrangement according to FIG. 4 with identical flap position.

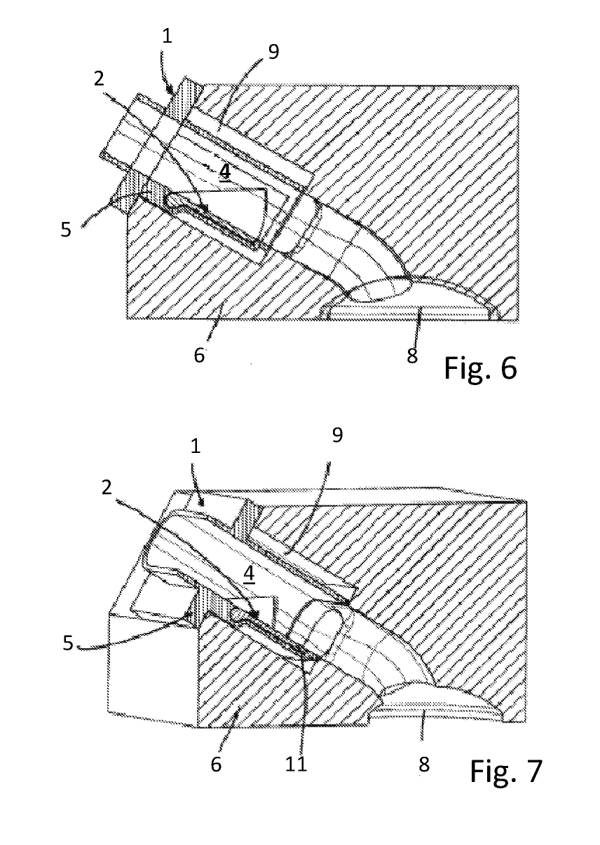

FIGS. 6 and 7 show the same arrangement of the switching unit 1 in the cylinder head as in FIGS. 4 and 5, but with a fully open flap 11. The air intake channel 4 is not reduced in cross-section. The air can flow into the combustion chamber without hindrance. Turbulence is not generated, the pressure drop in the intake channel is not increased by the fully open flap 11.

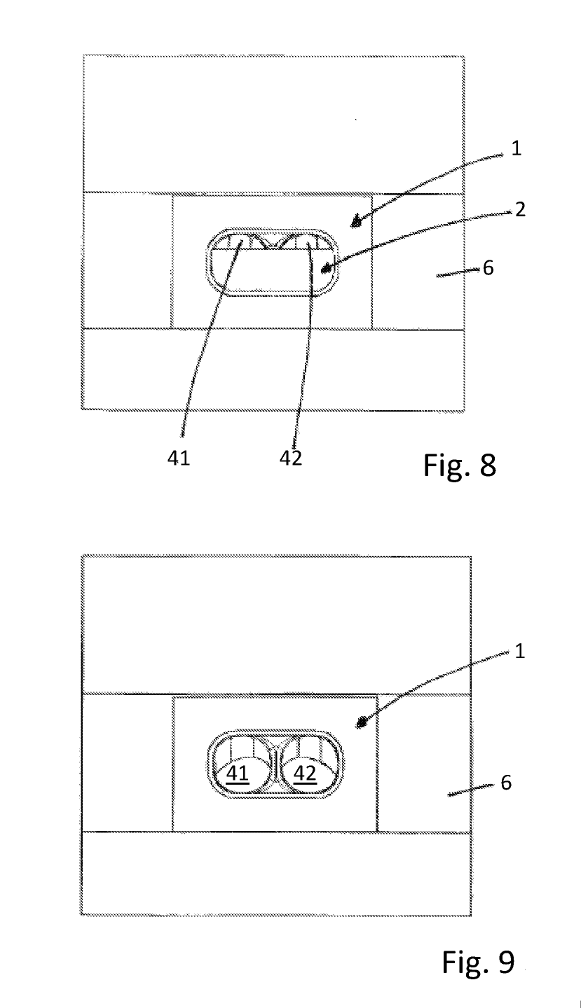

FIGS. 8 and 9 show a view of a switching unit 1 in a cylinder head 6 with a divided intake channel. The intake channel 4 of the previous representations is divided in this embodiment into two intake channels 41, 42. Both intake channels 41, 42 can be partially closed with a switching element 2, as shown in FIG. 8.

FIG. 9 shows the same arrangement as FIG. 8, but with complete opening of the switching element 2. In this operating state, air can flow unhindered into the combustion chamber.

What is claimed is:

1. A switching device for influencing the air current in at least one air intake channel of an internal combustion engine, wherein the switching device comprises:
a housing having an open interior through which the air intake channel extends;
at least one switching unit arranged in the housing and having with at least one switching element for at least partially closing and opening the at least one intake channel;
wherein the housing is received in a cylinder head of an internal combustion engine and which has a distance corresponding to an air gap between the housing and the cylinder head in a radial direction.

2. The switching device according to claim 1, wherein
in predetermined operating states of the engine, the switching device induces a tumble current in the at least one air intake channel of the internal combustion engine.

3. The switching device according to claims 1, wherein
the housing of the switching unit is formed as a plastic part.

4. The switching device according to claim 1, wherein
the switching element is a flap which is operable to change an air current cross-section in the air intake channel.

5. The switching device according to claim 1, wherein
the switching element is as a rotary vane, which is operable to change an air current cross-section in the air intake channel.

6. A suction system for intake air of an internal combustion engine, comprising
a switching device for opening or partially closing an air intake channel according to claim 1.

7. An intermediate flange for intake air of an internal combustion engine, comprising
a switching device for opening or partially closing an air intake channel according to claim 1.
